(19) United States
(12) Patent Application Publication
(10) Pub. No.: US 2007/0164650 A1
(43) Pub. Date: Jul. 19, 2007

(54) Support means of a frame/mask assembly for cathode ray tubes

(76) Inventors: Carlo Tulli, Rome (IT); Pedro Cosma, Roma (IT); Paolo Ginesti, Gavignano (IT)

Correspondence Address: Joseph J Laks;Vice President Patent Operations, Thomson Licensing Inc, P O Box 5312, Princeton, NJ, 08543-5312, US

(21) Appl. No.: 10/589,816

(22) PCT Filed: Jan. 31, 2005
(86) PCT No.: PCT/FR05/50059

§ 371 Date: Aug. 17, 2006

(30) Foreign Application Priority Data
Feb. 23, 2004 (IT) MI2004A000302

(51) Int. Cl. H01J 29/81; H01J 29/80

(52) U.S. Cl. 313/404; 313/407

(57) ABSTRACT

Cathode ray tube comprising a colour selection frame/mask assembly suspended within the front face of the said tube by suspension means composed of a first metal member comprising a central elastic part, a first extremity portion comprising a aperture designed to fit around a pin joined to the front face of the tube, and a second extremity portion attached by welding directly or indirectly to the frame the welding being carried out on the surface of the second extremity portion in at least two separate zones arranged in such a manner so as to form an acute angle Θ with the hole of the first extremity portion greater than 10°. This support structure enables the tube to be made less sensitive to mechanical vibrations.

The present invention relates to a colour cathode ray tube with a noticeably flat screen, and more specifically support device of a colour selection frame/mask assembly equipping such a tube.

The invention finds its application in any type of tube comprising a colour selection mask and is just as suitable for tubes with a mask that is realized by stamping and is held in place within the tube by a rigid frame to which it is joined, as for tubes with a mask tensioned in at least one direction and maintained in tension by attachment to at least one pair of opposite sides of the frame.

A conventional cathode ray tube comprises a glass envelope under vacuum. Within the envelope, the tube comprises a colour selection mask located at a precise distance from the glass front face of the tube, front face on which red, green and blue luminophore networks are laid to form a screen. An electron gun arranged inside the rear part of the tube generates three electronic beams in the direction of the front face. An electromagnetic deflection device, generally located outside the tube and close to the electron gun has the function of deviating the electronic beams so as to sweep them over the surface of the panel on which the luminophore networks are arranged. Under the influence of three electronic beams each corresponding to a determined primary colour, the luminophore networks enable colour pictures to be reproduced on the screen, the mask enabling each determined beam to illuminate only the luminophore of the corresponding colour.

The colour selection mask must be arranged and maintained in a specific position within the tube during the operation of the tube. The mask support functions are realised owing to a generally very rigid rectangular metal frame on which the mask is conventionally welded.

For most colour cathode ray tubes, the frame/mask assembly is suspended in the front face of the tube owing to elastic support means joined to the frame co-operate with the lugs inserted in the glass wall of the tube.

The support means must have sufficient elasticity to enable the frame/mask assembly to be disassembled several times from the front face during the various phases of the manufacturing process of the luminophore network.

The support means are generally arranged in the middle of the sides of the frame, as illustrated by the U.S. Pat. No. 4,528,475 namely at the level of the corners of the said frame as illustrated for example by the patent EP207724; In all cases, considering the high number of insertion and de-insertion operations of the frame/mask assembly in relation to the front face, it may happen that the final position of said assembly, and therefore of the mask in relation to the luminophore screen, is slightly shifted in relation to said screen. This shift causes a decolouration of the images owing to the fact that the mask is not at the correct distance from the screen.

Moreover, in the case of a tube with a flat screen appearance, the radii of curvature defining the surface of the mask are large values. The mask then becomes highly sensitive to external vibrations; under the influence of external shock or mechanical vibrations, for example, acoustic vibration due to the loudspeakers of the television set in which the tube is inserted. The mask can then begin to vibrate according to its own resonant frequency. The consequences of the vibrations of the mask modify the landing zone of the electron beams on the screen of the tube, the points of impact of each beam being thus offset with respect to the associated luminophore network, thus creating a decolouration of the picture produced on the screen.

The invention proposes a support structure of the frame/mask assembly providing a good elasticity and which is not sensitive to shock and vibrations so as to provide the best guarantee of the distance required between the mask and the luminophore screen.

For this, the colour cathode ray tube according to the invention comprises:

a noticeably rectangular front face on the internal surface of which a luminescent screen is deposited,

a colour selection mask arranged opposite the luminescent screen, said mask being joined to a noticeably rectangular frame, comprising a pair of long sides and a pair of short sides,

elastic support means of the frame/mask assembly within the tube, at least one of these support means comprising a first metal member comprising a central elastic part, a first extremity portion comprising a hole designed to fit around a pin integral with the front face of the tube, and a second extremity portion attached by welding directly or indirectly to the frame

characterized in that the welding is carried out on the surface of the second extremity portion in at least two separate zones arranged so as to form with the hole of the first extremity portion an acute angle E) greater than 10°.

The principles of the invention and its advantages will be better understood from the following description and drawings, wherein:

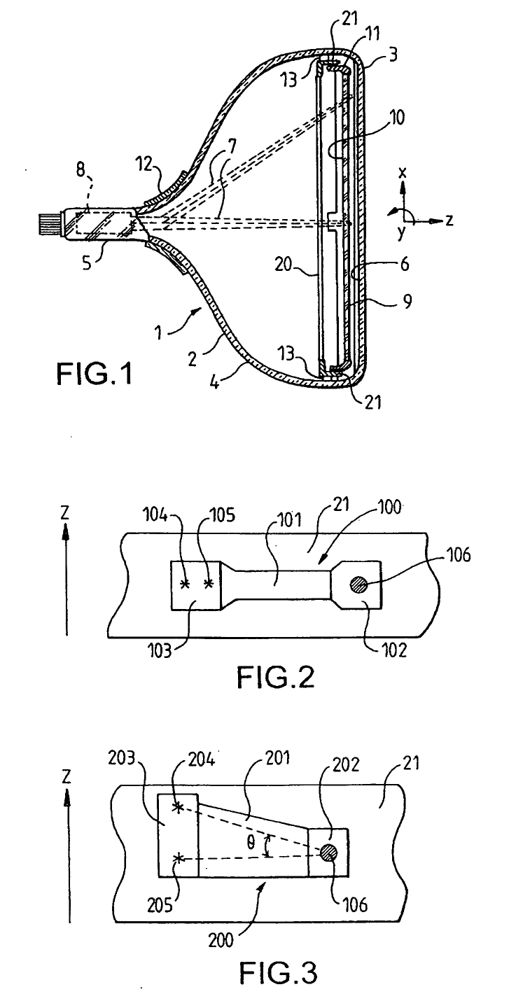

FIG. 1 illustrates a cross-section of a cathode ray tube with colour selection mask according to the longitudinal axis.

FIG. 2 shows the support means of a frame/mask assembly according to the prior art

FIG. 3 illustrates a first embodiment in accordance with the present invention

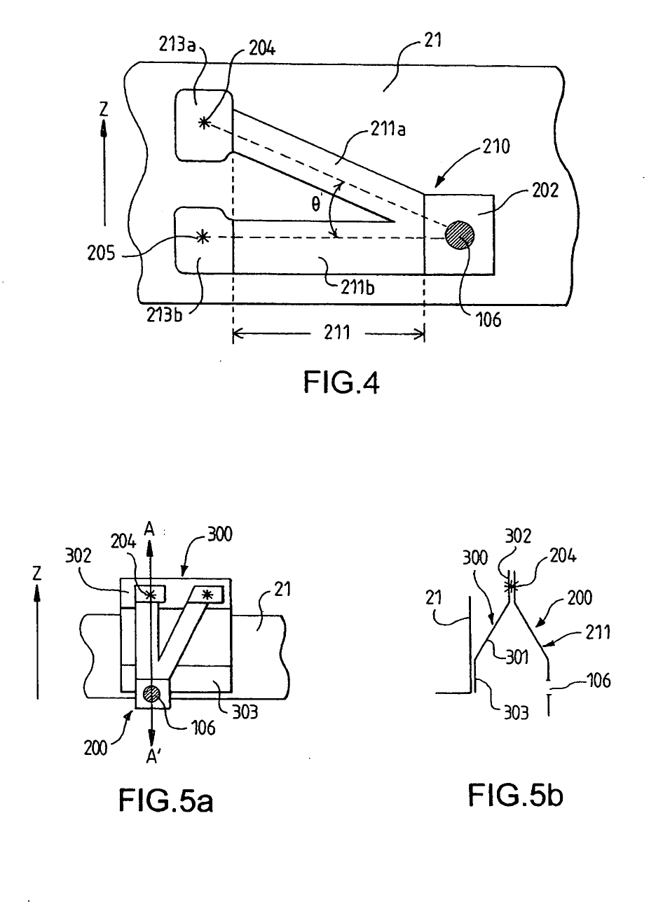

FIG. 4 shows a second embodiment of the present invention.

FIGS. 5a and 5b show an alternative embodiment of the present invention, respectively via a front view and cross-section view.

FIG. 1 shows a cathode ray tube 1 composed of an envelope under vacuum 2 comprising a noticeably rectangular front face 3 and a rear part in the form of a funnel 4 terminating in a cylindrical collar 5. The front face is defined from a horizontal axis X, parallel to its greatest dimension, and a vertical axis Y, parallel to its smallest dimension; the axes X and Y meet at the centre of the front panel and are perpendicular to the main longitudinal axis Z that passes through the centre of the cylindrical collar 5 and through the centre of the front face 3.

A screen of luminescent materials is arranged on the internal part of the front face 3, these materials being excited by the sweeping of electron beams 7 from an electron gun 8 arranged in the collar of the tube.

The sweeping of the electron beams is realized by a magnetic deflection device 12 arranged on the collar of the tube.

Within the glass envelope, a colour selection mask 9 is arranged, comprising a perforated surface 10, noticeably parallel to the surface of the screen 6, and a skirt 11, folded in a direction noticeably parallel to the longitudinal axis Z.

A frame 20 with an L-shaped cross-section is assembled within the glass envelope in such a manner as to position the mask at a specific distance from the luminescent screen. The frame comprises a flange 21 that extends practically in a direction parallel to the axis Z. The flange 11 of the mask is arranged within the frame and spot welded to the flange 21.

The frame/mask assembly is held in place in the glass envelope by means of the pins 13 included in the glass envelope cooperating with the support means in the form of springs joined to the frame.

FIG. 2 illustrates a support means structure 100 according to prior art.

This support is realized for example from an extended metal part, comprising a central elastic part 101 of which a first extremity 102 features an opening 106 designed to fit around the pin 13 of the glass envelope; the metal plate 100 comprises a second extremity 103 folded in such a manner that its surface can be welded for example at two spots 104 and 105 on the flange of the frame. As illustrated in the patent U.S. Pat. No. 4,528,475, the support according to this structure is advantageously joined to the middle of the sides of the frame, the weld spots 104 and 105 being noticeably aligned with the opening 106.

The metal plate 101 can be constituted by a single type of alloy, for example stainless steel, or by a bimetal designed to compensate in a known manner for the transient movements of the frame/mask assembly due to the thermal behaviour of said assembly during the operation of the tube.

However, this type of support structure cannot provide a sufficient mechanical rigidity particularly for tubes for which the front face and surface of the mask are noticeably flat.

The support structure according to the invention enables its rigidity to be increased and the tube to be made less sensitive to the vibrations of its environment.

FIG. 3 illustrates a first embodiment of the invention.

The support 200 is realized from a metal plate of constant thickness, made of a single alloy or a bimetal. It comprises a central part 201 forming a spring, a first extremity portion 202 folded with respect to the central part and pierced by an opening 106 designed to fit around a pin included in the front face of the tube and a second extremity portion 203 folded in such a manner as to be able to rest against the surface of the frame.

The central part 201 of the support 200 broadens from the first extremity portion 202 toward the second extremity portion 203. In this manner, the second extremity portion 203 has a width according to the direction of the longitudinal axis Z greater than the first extremity portion 202. The second extremity portion 203 is welded in at least two spots 204, 205 to the flange of the frame; these two weld spots are arranged in accordance with a direction noticeably parallel to the Z-axis so as to form an acute angle Θ with the summit shown by the opening 106. Experience shows that the value of this angle Θ must preferably be chosen to be greater than 10° to provide a sufficient increase in mechanical rigidity to improve the behaviour of the tube faced with external vibrations. Taking into account the constraints of space and the size of the different parts constituting the tube, the best compromise at the mechanical rigidity level of the supports 200 in relation to these constraints leads to the selection of Θ between 10° and 50°. However, these values are not restrictive and the value of Θ can be advantageously chosen to be greater than 50° for tubes of very large dimensions.

FIG. 4 illustrates a second embodiment of the invention. The support 210 according to this embodiment is realized from a metal plate of constant thickness, made of a single alloy or a bimetal. It comprises a first extremity portion 202 pierced by an opening 106 designed to fit around a pin included in the front face of the tube, a central part 211 constituted by two arms 211a and 211b linked with the first extremity portion, the folded extremities 213a and 213b of the two arms constituting the second extremity portion 213 of the said support 210. The two arms form an angle preferentially chosen between 10° and 50° for the same reasons as for the first embodiment and the welds on the flange of the frame are made on the said extremities 213a and 213b.

This embodiment has two advantages:

it reduces the quantity of material used to implement the invention

the two-arm support structure attenuates the vibrations of the frame/mask assembly more noticeably at the resonant frequency of the assembly, a frequency normally situated between 60 Hz and 100 hz.

FIGS. 5a and 5b illustrates an alternative embodiment for which the support means comprise a first elastic member such as described in the previous embodiments, said first member being welded not directly to the frame but to a second member 300 itself welded to the frame.

FIG. 5a shows a partial view of the support means composed of a first elastic member 200 comprising two arms 211a and 211b whose extremities are attached to a second member 300. This second member is realized using a metal plate of which the extremities 302 and 303 are folded in relation to its central part 301 so that these extremities can be attached respectively to the extremities 213a and 213b of the arms of the first member and to the surface of the flange 21 of the frame.

FIG. 5b shows the support means in position according to a cross-section plane A-A′ parallel to the longitudinal axis Z and perpendicular to one of the arms of the first member 200.

The second member enables the first elastic member 200 to be attached to frame at a point in the space at which the frame itself is not physically found.

Moreover, this second member can contribute to the movements of the frame/mask assembly during the heating transients on switching on the tube, movements due to the expansion of the frame. At that specific time.

These movements are controlled by choosing for example the thickness of the material constituting the second member; either this thickness is of the same order as the material of the first member and the expansion of the frame is then absorbed by the elasticity of the two members, or this thickness is greater, making the second member rigid with respect to the first and the expansion of the frame is then absorbed by the first member.

The above examples are not restrictive. A cathode ray tube can comprise a single support in accordance with the invention in combination with other supports according to the prior art. Hence, for example, this support in accordance with the invention will be attached in the middle of one of the sides of the frame in combination with four supports according to the prior art themselves arranged at the four corners of the said frame.

Alternatively, two supports in accordance with the invention can be attached to two opposite sides of the frame. Advantageously, so as to reduce the number of parts to use, all the supports of the frame can be constituted by supports in accordance with the present invention.

1/ Colour cathode ray tube comprising:
a noticeably rectangular front face on the internal surface of which a luminescent screen is deposited,
a colour selection mask arranged opposite the luminescent screen, said mask being joined to a noticeably rectangular frame, comprising a pair of long sides and a pair of short sides,
elastic support means of the frame/mask assembly within the tube, at least one of these support means comprising a first metal member comprising a central elastic part, a first extremity portion comprising a hole designed to fit around a pin integral with the front face of the tube, and a second extremity portion attached by welding directly or indirectly to the frame
wherein the welding is carried out on the surface of the second extremity portion in at least two separate zones arranged so as to form with the hole of the first extremity portion an acute angle Θ greater than 10°.

2/ Cathode ray tube according to claim 1, wherein the central part of the said support means comprises at least two separate arms linked with the first extremity portion, and for which each extremity comprises one of the welding zones.

3/ Cathode ray tube according to claim 1, wherein the said at least one of these support means moreover comprises a second metal member in the form of a plate of which one of the extremities is welded to the surface of the frame and the other extremity to the second extremity portion of the first metal member.

4/ Cathode ray tube according to claim 1, wherein the said at least one of these support means is attached to the frame in a corner of this frame.

5/ Cathode ray tube wherein the support means of the frame/mask assembly are all in accordance with claim 4.

6/ Cathode ray tube wherein it comprises at least two support means in accordance with claim 1, joined to two opposite sides of the frame.

7/ Cathode ray tube according to claim 1, wherein the front face of the tube is noticeably flat.
